(19) United States
(12) Patent Application Publication
(10) Pub. No.: US 2022/0054348 A1
(43) Pub. Date: Feb. 24, 2022

(54) WEARABLE CUBITAL TUNNEL SYNDROME PREVENTION AND TREATMENT DEVICE

(71) Applicant: Kun-Yen Chung, Tainan City (TW)

(72) Inventor: Kun-Yen Chung, Tainan City (TW)

(21) Appl. No.: 16/995,841

(22) Filed: Aug. 18, 2020

(51) Int. Cl. A61H 11/00; A61H 7/00

(52) U.S. Cl. CPC A61H 11/00; A61H 7/002; A61H 2205/06; A61H 2201/1635; A61H 2201/1692; A61H 2201/165; A61H 2201/1253

(57) ABSTRACT

A wearable cubital tunnel syndrome prevention and treatment device is an auxiliary tool for the protection of cubital syndrome, using two long plate-typed main bodies with a convexly curved outer edge of the same shape to attach to the outer skin surfaces of the extensor and flexor tendon g with a fan-shaped spherical arc surface arranged in equal intervals on the inner side surface of the main body. The two extended sides of the outer edge surface of the main body cover both ends of the whole main body by means of the pass-through of the band or bonding, allowing convex arc rings to buckle the assembly tightly with the band, achieving the effect of holding and positioning and applying pressure with the elbow, and the effect of doing multiple point massage to the muscle groups of the extensor and flexor tendons on both sides of the elbow synchronously.

### TECHNICAL FIELD OF THE INVENTION

The present invention relates to a wearable cubital tunnel syndrome prevention and treatment device that is an auxiliary device designed to provide simple and convenient buckling, which can relax the tendons on both sides of the elbow and do in-depth massage to relieve the tension and discomfort of exercise.

### DESCRIPTION OF THE PRIOR ART

Modern people, no matter in life, work, sports and other activities, have a lot of reciprocating movements through their forearms. In particular, some of them have to rely on their elbows to forcefully do the same posture or action repeatedly. Exercises such as long-term cleaning work, cooking, tennis, golf, etc., using elbow extension and flexion to exert force to do repetitive actions, often cause local elbow soreness and pain symptoms commonly known as a tennis elbow or golf elbow symptom, which has another name; cubital tunnel syndrome. Especially, the hand discomfort generated after modern people use a bent hand to hold a mobile phone to do local long-term force work (even worse, it affects wrist exertion or bending pain) is mainly due to the same repetitive action or improper action. As a result, due to excessive fatigue of the elbow tunnel tendon, muscle weakness and soreness are caused.

In fact, the two symptoms mentioned above are not bone problems, but the pathological diseases caused by the fatigue of the tenacity between the tendons and collaterals used for stretching. As far as medical behavior is concerned, pain relief and rehabilitation are mostly carried out simultaneously; when medication is used, it is very likely that some body organs may have side effects, and in terms of rehabilitation behavior, the main method is basically the recovery of fatigue from tendon injuries, and it usually takes a long period of rehabilitation assistance to recover. In particular, traditional rehabilitation mostly uses hot compress or traction, which can achieve very limited effect for the injured part of tendon groups in elbow. Especially cubital tunnel syndrome is the sore symptoms that occurs in the elbow, also known as ulnar neuropathy; because the ulnar nerve passes through the elbow, there is almost no fat and subcutaneous tissue. When the strain of the tendon group caused by excessive fatigue or improper stress, the surface of the skin will be extremely sensitive, and a slight touch will be like an electric shock, so treatment is very slow and uncomfortable. Many existing developed rehabilitation tools disclosed by the patents such as U.S. Pat. Nos. 6,149,617 and 8,628,488 B2 are all designed to provide elbow protection. In view of their designs, a single convex arc structure is often used, and the band is used to bind the extensor tendons that apply force to the elbow for unilateral compression and tightening protection mainly for the elbow extensor tendon compression bundle, thereby preventing excessive tension of the extensor tendon group under local application of force to cause fatigue of improper force so as to form an injury to the elbow tendons group, and achieving the sports safety effect of preventing elbow injuries. However, with a similar single flange plane as a compression protection design, for the effect of the entire elbow tendon group, the convex arc part can only achieve the effect of surface compression to prevent deformation. In terms of the relaxation effect of the whole muscle in the exercise stress compression tension fatigue, it can not effectively release the pressure, and the improvement of elbow pressure is very limited; its continuous compaction will instead form the tension of the extensor tendon, which is not easy to relax, so that the purpose of protection is lost. Especially, with the one-sided compression design of the one-piece type, the part of the opposite flexor tendon on the other side is like an untreated unilateral force situation; it naturally forms a sequel effect of another kind of pressure, and it is very easy to form another reaction situation; for the normal elbow force and pressure release, there is obviously a relative pressure deviation, but this improper pressure relief design has never seen proper auxiliary improvement design or use, and only for the improper pressing design part of a single convex arc surface, there is another development design that a continuous convex arc flange is used as a covering surface as disclosed in U.S. Pat. No. 8,821,425 B2, which uses two parallel ribs design to mainly provide a hollow interior with cold and hot compression assistance function, but the long stripe surface is designed to cover in the same direction as the shrunk band surface; for the entire bundled extensor tendon group, it is like a transverse cut-off bundle compression, and the compression force is just perpendicular to the muscle stretching direction, that is, the tighter the bundle is, the more obvious the discomfort of the muscle will be, which cannot effectively relieve the whole elbow uncomfortable bundle situation. Obviously, the designs of the above effective assistant tools in relation with cubital tunnel syndrome only are designs that only a single side is used for the compression and pressure relief. Regarding the development and use of similar products, for many people who use their elbows to do instant or continuous exercise or work, the tennis elbow type sports injury problems caused by work or exercise have not been overcome.

### SUMMARY OF THE INVENTION

The inventor of the present inventor has a great understanding of the uncomfortable conditions such as pain, weakness and other symptoms of tennis elbow derived from the aforementioned cubital tunnel syndrome. Especially based on years of experience in the development of assistive devices, the wearable cubital tunnel syndrome prevention and treatment device of the present invention is finally developed. In the present invention, two opposing main bodies are clamped on both sides of the elbow, and convex arc rings with fan-shaped arc surfaces are arranged at intervals on the inside of the main body, so that it is in a forward direction with the muscle fibers on both sides of the elbow. With the Pressing and adjusting with the band to tighten and wrap, the protruding convex arc rings press deeply inside the extensor and flexor tendon groups on both sides of the elbow. During elbow activities, the tension and discomfort of the extensor and flexor tendon groups are effectively and appropriately relieved, which greatly overcomes the defects of discomfort and possible injures during elbow activities.

The main object of the present invention provide a wearable cubital tunnel syndrome prevention and treatment device, using a band to pass through the two opposing main bodies and connected them together, and the fan-shaped convex arc rings respectively configured on the opposing inner side surfaces of the main bodies are respectively covered on the outsides of the extensor tendon group and flexor tendon group on both sides of the elbow, allowing the vertically arranged convex arc rings to be directly attached to the extensor and flexor tendons of the elbow in a forward manner. The band on the outer edge surfaces of the main bodies buckling the outside of the elbow tightly allows the convex arc rings to be tightly buckled to press deeply into the tendon groups of the elbow to massage them. In this way, when the elbow exerts force to do sports or work, the convex arc ends of the convex arc rings can form a relaxing operation of interval massage on the internal tendon groups, achieving the purpose of auxiliary use of elbow movement safety.

### BRIEF DESCRIPTION OF THE DRAWINGS

FIG. 1 is an exploded view of the present invention;

FIG. 2 is a perspective view of the present invention;

FIG. 3 is a schematic view of the present invention when worn on an elbow; and

FIG. 4 is a perspective view of the present invention when worn on an elbow.

### DETAILED DESCRIPTION OF THE PREFERRED EMBODIMENTS

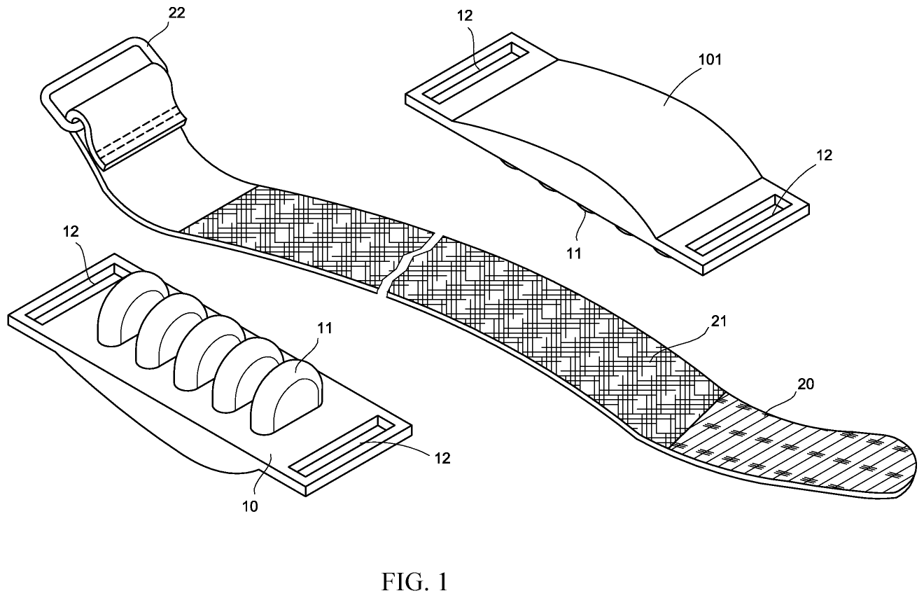

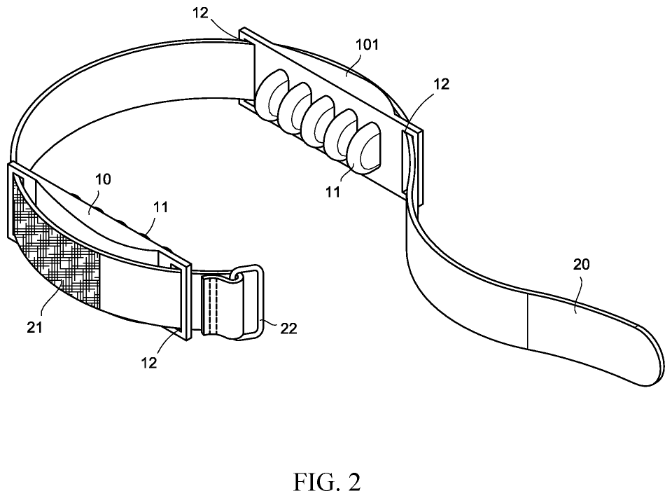

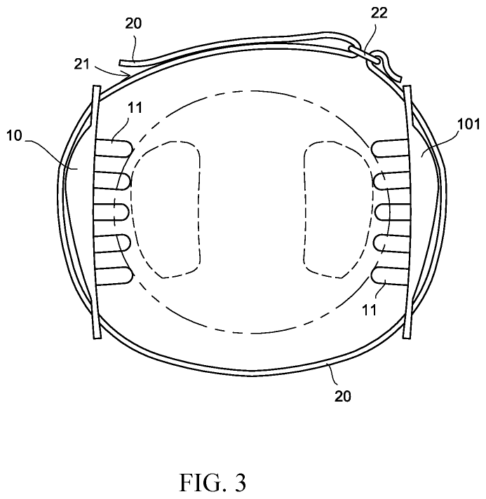

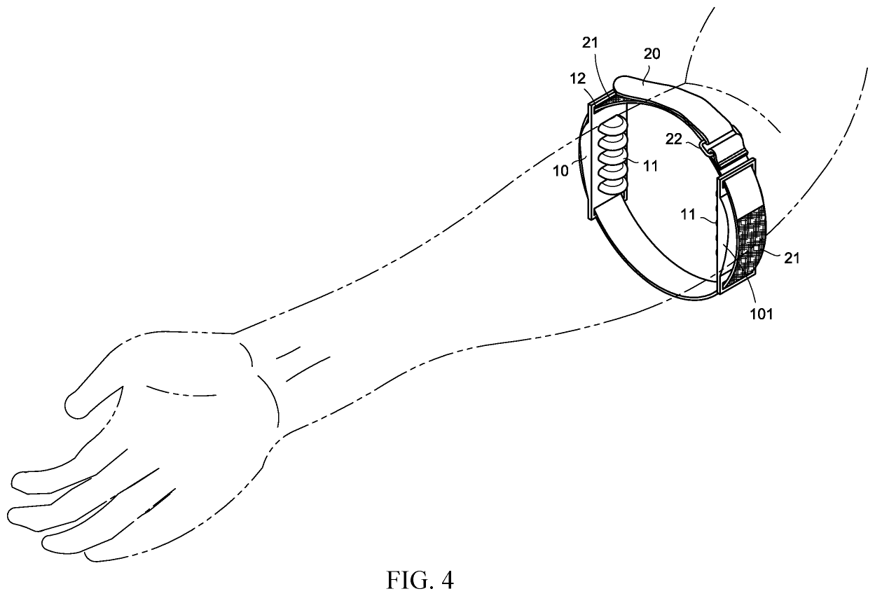

A wearable cubital tunnel syndrome prevention and treatment device of the present invention is a safety protection auxiliary tool used to prevent the tendon group from injury, known as tennis elbow or golf elbow symptom. Referring to FIGS. 1 to 4, it includes first and second main bodies 10, 101 in the same rectangular plate shape, one side of the rectangular plate of each of the main bodies 10, 101 is a convex curved surface, and another side is configured with a plurality of fan-shaped convex arc rings 11 spaced in the shape of a comb, where both ends of each of the first, second main bodies 10, 101 are respectively configured with an extended through hole seat 12, allowing a band 20 to be passed through the through hole seat 12 on the one end of the first main body 10, then covered around the convex curved surface, and finally passed through the through hole seat 12 on the other end, which can be done on the second main body 101 in the same way, thereby forming a complete cubital tunnel protection auxiliary device that can be used to buckle relatively on both sides. With the cubital protection device design of the present invention, the single band 20 is passed the same long plate-typed first, second main bodies 10, 101, allowing the opposite first, second main bodies 10, 101 to be respectively attached to the outer skin surface of the extensor and flexor tendons on both sides of the elbow. Thus, the buckling assembly of the same band 20 operated in coordination of the simple sticking and fixing of the male and female tape surfaces of the Velcro tape (21) achieves convenient operation and use. If the width of the long plate surface of each of the first and second bodies 10, 101 is not more than 3 cm, the buckling property is better, and the highest position of the convex curved surface thereof being not more than 10 mm is the best. Furthermore, the section of the convex arc ring 11 is in a circular arc shape, and the thickness and spacing are between 5 mm and 7 mm; the projection height of the entire convex arc ring 11 is no more than 15 mm. Upon assembly, the band 20 is respectively passed through the spaced first and second main bodies 10, 101 in sequence, and the first and second main bodies 10, 101 are then spaced at proper positions on the upper side of the band 20, forming a cubital protection auxiliary device having simple adjustment and attaching positions and massage effect.

When the present invention is put around the elbow for use, the first main body 10 is placed on an external skin surface of the extensor tendon after the elbow is placed flat. In addition, the second main body 101 placed on the band 20 is adjusted to attach it to the outside of the flexor tendon on the other side of the elbow after going around the midline of the elbow. Thereafter, the band 20 is wrapped around the elbow and passed through a fixing ring 22 on the head end of the band 20 and folded back. With a female surface of a Velcro tap 21 sewn on the inner surface of the band 20, the band 20 can be bonded to the male surface sewn on the back surface of the band 20 for the buckling and positioning, so the whole elbow protection auxiliary device can safely and reliably cover the extensor and flexor tendons on both sides of the elbow. With the pressure of the bundle and the convex arc design of the outer edges of the first and second bodies 10, 101, the present invention has the use effect of the unequal height load-bearing base, allowing the comb-typed gradually arranged convex arc rings 11 to generate different buckle pressures according to different stress points, achieving the compression massage effect of tendon groups. Especially, the comb-shaped convex arc rings 11 are arranged in the same direction as the stretch of the tendon group. When the elbow force is changed, the natural reflection operation of compressing and releasing between the convex arc rings 11 can be achieved synchronously, and the exact massage goes deep into the fasciae of the tendon groups. In this way, the blood flow in the compression part of the tendon group can be supplemented appropriately to prevent pain or injury. The design of the Velcro tape allows the tightness of the band 20 to be able to be conveniently adjusted, achieving the wearing convenient, which is especially convenient for uses to easily adjust the positions of the first and second main bodies 10, 101 by sliding according to their elbow thicknesses, achieving the simple adjustment of the compression position, and the effect of practical safety protection.

The same band 20 is passed through the two identical first and second main bodies 10, 101, allowing an maneuver slip adjustment to be done on the two main bodies 10, 101; it is convenient for users to adjust the mutual position of the first and second bodies 10, 101 of the actual bundle, making sure that the convex arc rings 11 arranged at intervals are pressed against and bundle the tendon groups one after another according to the forward direction thereof, and achieving the correct pressing assembly and the practical effect of elastic bundle safety protection or treatment. Furthermore, Through the special gradual pressing of the spaced forward convex arc rings 11, with the stress characteristics of different pressing points generated by the arc-shaped surface binding when the arc-shaped edge surfaces of the first and second bodies 10, 101 are attached to the band 20, depending on the position of the tendon group, it can achieve different pressing and force use effects, and indeed achieve the transformation of the force with the elbow movement, To ensure the balance pressure adjustment of elbow tendon group, effectively achieve the purpose of elbow protection and treatment after injury. The whole elbow protection auxiliary device is simply installed on both sides of the elbow through two relatively assembled first and second bodies 10, 101. After being wrapped and tightened, the elbow can move synchronously to achieve the simultaneous massage and soothing operation of the inner and outer tendons of the elbow, thereby providing relief of elbow pain; the assembly and disassembly of the entire set of auxiliary tool can only be easily done through the band 20, and the change of the bundle pressure can also be adjusted and changed simultaneously; the whole use is extremely convenient and simple, without special technical dependence; under the effective action, the volume is minimized to extend the wearing time and increase comfort, and oneself can use and operate easily; regarding the design and use of its device structure, there has never been a public release of the same development and design, the present invention is indeed a new design of safety prevention aids for elbow protection.

To sum up, the wearable cubital tunnel syndrome prevention and treatment device of the present invention allows the band to be passed through the two opposing assembled bodies, and them to be easily buckle the outside of the extensor and flexor tendons on both sides of the elbow; with the tight buckling of the band, the projecting fan-spaced spaced convex arc rings are allowed to press deeply into the tendon groups and massage them, effectively promote the aerobic exercise effect of increased blood flow due to massage at the place where the force is applied to the tendon, preventing sports injuries from occurring, and achieving the practical effect of relaxing and soothing the elbow due to massage, and the overall design is extremely easy to assemble and use, and it can be easily assembled and used without any special technical dependence. Therefore, the present invention can really achieve the safe protection and of the elbow and the practical effect of treatment.

I claim:

1. A wearable cubital tunnel syndrome prevention and treatment device, comprising first and second main bodies in the same rectangular plate shape, one side of said long plate having a convex arc-shaped curved outer edge surface, and the other side of said long plate having a plurality of fan-shaped convex arc rings arranged at intervals like a comb shape, wherein, outer sides of said first and second main bodies are wrapped and positioned by a band, together to form an auxiliary device that can be worn on both sides of an elbow to cover the extensor and flexor tendons; through the buckle of said band, said elbow can be buckled and compressed; said convex arc rings arranged at intervals can press deeply into said elbow extensor and flexor tendon muscle groups to achieve the purpose of soothing protection and effective treatment.

2. The device according claim 1, wherein the extension height of said convex arc ring projected upward from said plate surface is less than 15 mm.

3. The device according to claim 1, wherein the interval between said two adjacent convex arc rings is between 5 mm and 7 mm.

4. The device according to claim 1, wherein the width of said long plate surface of each of said first and second main bodies is less than 3 cm, and the highest height of an outer edge convex arc is less than 10 mm.

5. The device according to claim 1, wherein two ends of a curved long plate of each of said first and second main bodies are respectively configured with a through hole seat, allowing said band to be passed therethrough for covering and buckling.

6. The device according to claim 1, wherein said curved outer edge surfaces of said first and second main bodies are bonded and assembled with said band with Velcro.

7. The device according to claim 1, wherein the head end of the band is provided with a fixing ring for buckling, passing-through and assembly.
